(19) United States
(12) Patent Application Publication
(10) Pub. No.: US 2017/0134775 A1
(43) Pub. Date: May 11, 2017

(54) METHOD FOR SYNCHRONIZING DATA, AND ELECTRONIC DEVICE

(71) Applicants: LE HOLDINGS (BEIJING) CO., LTD., Beijing (CN); LE SHI ZHI XIN ELECTRONIC TECHNOLOGY (TIAN JIN) LIMITED, Tianjin (CN)

(72) Inventor: Xing YANG, Tianjin (CN)

(21) Appl. No.: 15/225,909

(22) Filed: Aug. 2, 2016

Related U.S. Application Data
(63) Continuation of application No. PCT/CN2016/082144, filed on May 13, 2016.

(30) Foreign Application Priority Data
Nov. 10, 2015 (CN) 201510762655.7

(51) Int. Cl. H04N 21/242; H04N 21/2187; H04N 21/472; H04N 21/43; H04N 21/858; H04N 21/64

(52) U.S. Cl. CPC H04N 21/242; H04N 21/8586; H04N 21/64; H04N 21/47202; H04N 21/4302; H04N 21/2187

(57) ABSTRACT

Embodiments of the disclosure provide a method and apparatus for synchronizing data so as to address the problem in the prior art that only on-demand videos but not live videos can be synchronized in the existing technologies of video data synchronization. In the method according to the disclosure, after a server determines that a video played by a second device bound with a first device is a live video, the server determines an end time of a program corresponding to the live video played by the second device, according to lastly determined progression information of the video played by the second device; and the server transmits a first Uniform Resource Locator (URL) network address corresponding to a channel of the live video to the first device upon determining from the end time that the program corresponding to the live video is not terminated.

### CROSS REFERENCE TO RELATED APPLICATIONS

This application is a continuation of International Application. No. PCT/CN2016/082144, filed on May 13, 2016, which is based upon and claims priority to Chinese Patent Application No. 201510762655.7, filed on Nov. 10, 2015, the entire contents of which are incorporated herein by reference.

### TECHNICAL FIELD

The present disclosure relates to the field of display technologies, and particularly to a method and apparatus for synchronizing data.

### BACKGROUND

At present, videos watched by people over the internet are generally categorized into on-demand videos and live videos. The on-demand videos refer to videos stored by a server at a fixed position, and the sizes and contents of the on-demand videos are fixed, e.g., a film, a segment of video record, etc. The live videos refer to video contents played live, and the sizes and contents of the live videos are variable, e.g., live videos available from a normal TV station or an Internet TV station over the Internet, personal live videos on a live video platform, etc.

The inventors have identified during making of the invention that the live videos have the advantage of being real time as compared to the on-demand videos, but require a high Internet speed for the videos to be real time. In recent years, the live videos become increasingly popular along with a growing Internet speed and a decreasing cost of accessing the Internet. Some significant competitions, and programs broadcast live can be available among the live videos over the Internet.

There are various existing display devices on which the on-demand videos and other videos are watched, e.g., mobile phones with large screens, tablet computers, smart TV sets, etc. Users watching videos with a low quality of picture on their mobile phones while they are not at home frequently prefer to watch again the videos they have watched, on TV sets on which the videos with a higher quality of picture can be watched at home, so the technologies of video data synchronization have emerged in response to this. With the existing technologies of video data synchronization, only the on-demand videos but not the live videos can be synchronized.

### SUMMARY

Embodiments of the disclosure provide a method and electronic device for synchronizing data so as to address the problem in the prior art that only the on-demand videos but not the live videos can be synchronized in the existing technologies of video data synchronization.

In an aspect, embodiments of the disclosure provides a method for synchronizing data, the method including:

upon determining that a video played by a second device bound with a first device is a live video, determining, by a server, an end time of a program corresponding to the live video played by the second device, according to lastly determined progression information of the video played by the second device; and

transmitting, by the server, a first Uniform Resource Locator (URL) network address corresponding to a channel of the live video to the first device upon determining from the end time that the program corresponding to the live video is not terminated.

In another aspect, embodiments of the disclosure provides an electronic device including:

at least one processor; and

a memory communicably connected with the at least one processor for storing instructions executable by the at least one processor, wherein execution of the instructions by the at least one processor causes the at least one processor to:

upon determining that a video played by a second device bound with a first device is a live video, determine an end time of a program corresponding to the live video played by the second device, according to lastly determined progression information of the video played by the second device; and

transmit a first URL network address corresponding to a channel of the live video to the first device upon determining from the end time that the program corresponding to the live video is not terminated.

In a further aspect, embodiments of the disclosure provides a non-transitory computer-readable storage medium storing executable instructions that, when executed by an electronic device, cause the electronic device to:

upon determining that a video played by a second device bound with a first device is a live video, determine an end time of a program corresponding to the live video played by the second device, according to lastly determined progression information of the video played by the second device; and

transmit a first URL network address corresponding to a channel of the live video to the first device upon determining from the end time that the program corresponding to the live video is not terminated.

With the methods and electronic device for synchronizing data according to the embodiments of the disclosure, the first URL network address corresponding to the channel of the live video played in the second device can be transmitted to the first device, so that data of the channel of the live video of the second device can be synchronized to the first device.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a system for synchronizing data in accordance with some embodiments;

FIG. 2 is a schematic structural diagram of a first apparatus for synchronizing data in accordance with some embodiments;

FIG. 3 is a schematic structural diagram of a second apparatus for synchronizing data in accordance with some embodiments;

FIG. 4 is a schematic flow chart of a first method for synchronizing data in accordance with some embodiments;

FIG. 5 is a schematic flow chart of a second method for synchronizing data in accordance with some embodiments;

FIG. 6 is a schematic general flow chart of a method for synchronizing data in accordance with some embodiments; and

FIG. 7 is a schematic diagram of an electronic device for synchronizing data in accordance with some embodiments.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

In a method for synchronizing data according to an embodiment of the disclosure, after a server determines that a video played by a second device bound with a first device is a live video, the server determines an end time of a program corresponding to the live video played by the second device according to lastly determined progression information of the video played by the second device; and the server transmits a first Uniform Resource Locator (URL) network address corresponding to a channel of the live video to the first device upon determining from the end time that the program corresponding to the live video is not terminated. Since the server in the embodiment of the disclosure can transmit the first URL network address corresponding to the channel of the live video played in the second device to the first device, data of the channel of the live video of the second device can be synchronized to the first device.

As illustrated in FIG. 1, a system for synchronizing data according to an embodiment of the disclosure includes a first device 10, a server 20, and a second device 30.

The first device 10 is configured to transmit heartbeat information periodically to the server 20 while a live video is being played.

The server 20 is configured, upon determining that the video played by the second device 30 bound with the first device 10 is a live video, to determine an end time of a program corresponding to the live video played by the second device 30, according to lastly determined progression information of the video played by the second device 30; and to transmit a first video list corresponding to the live video to the first device 10 upon determining from the end time that the program corresponding to the live video is not terminated.

The second device 30, which is a display device bound with the first device 10, has played the video before the first device 10 is connected to a network.

The first device 10 and the second device 30 in the embodiment of the disclosure are display devices on which a network video can be watched, or devices which are used to watch a network video together with a display device, e.g., a mobile phone, a Wireless-Fidelity (Wi-Fi) enabled tablet computer, a computer, a smart TV set, or a TV box. The first device 10 and the second device 30 can be the same type of devices. For example, if the first device 10 is a mobile phone, then the second device 30 may also be a mobile phone. The first device 10 and the second device 30 can alternatively be different types of devices. For example, the first device 10 is a mobile phone, and the second device 30 is a TV set.

The first device 10 and the second device 30 can be bound in the following two approaches without any limitation thereto.

In a first approach, they log into the same account.

If the server 20 determines that the first device 10 and the second device 30 log into the same account in the same or associated video applications, then the server 200 may bind the first device 10 with the second device 30. For example, if the server 20 determines that the second device 30 logs into an account 1, and further determines that the first device 10 logs into the account 1, then the server 20 may bind the first device 10 with the second device 30.

In a second approach, their physical addresses are associated with the same account.

The server 20 stores physical addresses of the first device 10 and the second device 30 which have logged into the same account of the same video application, and binds the first device 10 with the second device 30.

For example, if the server 20 determines that the first device 10 has logged into an account 1 of a video application, a user transmits a message to the server 20 to associate an Media Access Control (MAC) address of the first device 10 with the account 1, and the second device 30 logs into the account 1, then the server 20 may bind the MAC address of the first device 10 with the second device 30.

In an embodiment of the disclosure, before played video data of the second device 30 and the first device 10 are synchronized, the second device 30 plays an on-demand video or a live video, and transmits the data of the played video to the server 20. The data of the played video transmitted by the second device 30 can include but will not be limited to play state information, a general URL network address (i.e., the first URL network address) of the video, and the progression information.

The play state information indicates whether the video played by the second device 30 is a live video or an on-demand video. The second device 30 transmits the play state information in real time to the server 30 according to the type of the video watched by the user in the second device 30. For example, if the user watches an on-demand video on the second device 30, then the second device 30 may transmit the play state information of “On-Demand” automatically to the server 20, and the play state information stored in the server 20 may be “On-Demand”; and if the user subsequently watches a live video on the second device 30, then the second device 30 may transmit the play state information of “Live” automatically to the server 20, and the play state information stored in the server 20 may be “Live”.

The first URL network address refers to a network address of a channel of the live video, or a network address of the on-demand video, played by the second device 30. The first device 10 and the second device 30 can retrieve the live video of the channel, or the on-demand video, corresponding to the first URL network address from the server 20 through the first URL network address. The first URL network address of the channel of the live video, or the on-demand video is fixed, so the first device 10 and the second device 30 can watch the live video of the same channel, or the same on-demand video from the server 20 using the same first URL network address.

The user can select a live video of a channel on the second device 30 to thereby select a first URL network address, and send the first URL network address to the server 20. For example, the user can select a “Life Channel” on the mobile phone, and since the “Life Channel” corresponds to a first URL network address, the user selects the “Life Channel” so that the first URL network address corresponding to the “Life Channel” is transmitted to the server 20.

The user can alternatively select an on-demand video on the second device 30 to thereby select a first URL network address, and send the first URL network address to the server 20. For example, the user can select a “Comedy” on the mobile phone, and since the “Comedy” corresponds to a first URL network address, the user selects the “Comedy” so that the first URL network address corresponding to the “Comedy” is transmitted to the server 20.

After the user plays a live video of a channel or an on-demand video on the second device 30, the second device 30 may transmit a first URL network address to the server 20, and the server 20 may store the first URL network address.

The progression information can indicate a real instance of time of the live video being watched, or a progression of the on-demand video being watched. For example, if the second device 30 plays the on-demand video, then the second device 30 may play it up to the 40^{th} minute so that the progression information is 40 minutes; and if the second device 30 plays the live video, then the second device 30 may play it up to 9 o'clock so that the progression information is 9 o'clock.

The second device 30 transmits the heartbeat information periodically to the server 20 to update the progression information while playing the live video. The server 20 determines an instance of time when the heartbeat information is received, as progression information to replace the original progression information. For example, if the server 20 receives the heartbeat information transmitted by the second device 30 at 9 o'clock, then the progression information may be updated to “9 o'clock”, and if the server 20 thereafter further receives the heartbeat information transmitted by the second device 30 at 9:20, then the progression information may be updated to “9:20”. If the second device 30 playing the on-demand video closes the video application, then the second device 30 may transmit the last progression information of the on-demand video being played to the server 20. For example, if the second device 30 playing the on-demand video up to the 40^{th} minute closes the video application, then the second device 30 may transmit the progression information of “40 Minutes” to the server 20.

After the first device 10 bound with the second device 30 is connected to the network, the server 20 may synchronize the data of the video played by the second device 30 to the first device 10 in the following several operations.

In the operation 1, the server 20 determines whether the video played by the second device 30 is a live video.

The server 20 determines whether the video watched on the second device 30 is a live video or an on-demand video before the first device 10 is connected to the network (or logs into the same account as the second device 30).

Optionally the server 20 determines whether the video played by the second device 30 is a live video, in the following three approaches.

In a first approach, the determination is made according to a video list.

The server 20 determines a first video list according to the first URL network address corresponding to the video played by the second device 30 bound with the first device 10; and determines whether there is an end flag in the first video list; and if so, then the server may determine that the video played by the second device 30 is an on-demand video; otherwise, the server may determine that the video played by the second device 30 is a live video.

The first video list can be a segment of text, and can be retrieved by the server 20 at the first URL network address corresponding to the channel of the live video, or the first URL network address corresponding to the on-demand video. The first video list includes URL network addresses of video segments of the played video. A URL network address of a video segment represents a network address corresponding to a particular segment of video, and the first video list of the live video or the on-demand video can be consisted of a plurality of URL network addresses of video segments. A URL network address of a video segment includes a filename of the video segment, and the end of the filename can include a number so that the display device can retrieve and play the files of the video segments front the server 20 in an ascending order of their numbers. For example, if a URL 1 network address of a video segment in the first video list includes a filename “f1” of the video segment, and a URL 2 network address of a video segment in the first video list includes a filename of the video segment, then the display device may firstly play the video segment corresponding to the network address URL 1.

The video list of the live video includes a URL network address of a video segment being played, and URL network addresses of several video segments to be played. The number in a filename included in the URL network address of the video segment being played is the least. The video list of the live video is updated constantly by removing the URL network addresses of the video segments which have been played, and adding URL network addresses of video segments buffered and downloaded from the server 20. For example, the first video list includes “URL 1 Network Address of Video Segment, URL 2 Network Address of Video Segment, and URL 3 Network Address of Video Segment” at 9 o'clock, and the first video list is updated to include “URL 2 Network Address of Video Segment, URL 3 Network Address of Video Segment, and URL 4 Network Address of Video Segment” at 9:05.

In a real application, the first device 10 and the second device 30 going to play the live video need to download the latest first video list periodically at the first URL network address, and download the segments of the video from the server at the URL network addresses of the video segments in the first video list. Thus the server 20 needs to provide the first device 10 with the first URL network address corresponding to the channel of the live video played by the second device 30 so that the first device 10 can play the live video of the same channel as the second device 30.

The video list of the on-demand video includes the URL network addresses of all the video segments composing the on-demand video. Thus the second device 30 may not update the video list of the on-demand video after downloading it from the server 20.

In a real application, the first device 10 and the second device 30 going to play the on-demand video download the latest first video list at the first URL network address, and determine a video segment corresponding to a URL network address of the video segment that they request for downloading from the server 20, according to the progression information of the on-demand video being played in the first device 10 and the second device 30. For example, if the on-demand video is played up to the 30^{th} minute in the second device 30, a URL 10 network address of a video segment corresponds to the video segment from the 30^{th} to 31^{st} minutes of the on-demand video, and a URL 11 network address of a video segment corresponds to the video segment from the 31^{st} to 32^{nd} minutes of the on-demand video, then the second device 30 going to further play the on-demand video may firstly download the video segment from the 30^{th} to 31^{st} minutes of the on-demand video at the URL 10 network address of the video segment, and then pre-download the video segment from the 31^{st} to 32^{nd} minutes of the on-demand video corresponding to the URL 11 network address of the video segment, so that the second device 30 can play the video segment from the 31^{st} to 32^{nd} minutes of the on-demand video smoothly following the video segment of the 30^{th} to 31^{st} minutes of the on-demand video.

The first video list of the live video is different from the first video list of the on-demand video in that there is no end flag (e.g., END) in the first video list of the live video, and there is an end flag in the first video list of the on-demand video. Thus it can be determined whether the video played by the second device 30 is a live video, by determining whether there is an end flag in the first video list. For example, the first video list of the live video includes URL 1 Network Address of Video Segment URL 2 Network Address of Video Segment, and URL 3 Network Address of Video Segment; and the first video list of the on-demand video includes URL 1 Network Address of Video Segment, URL 2 Network Address of Video Segment, URL 3 Network Address of Video Segment, and END.

In a second approach, the determination is made according to the play state information.

The server 20 determines whether the video played by the second device 30 is a live video, according to the play state information from the second device 30.

When the second device 30 plays the live video or the on-demand video, the second device 30 may transmit the play state information to the server 20. The play state information can be a text, or can be a number representing “Live” or “On-Demand”. For example, if the user plays the live video on the second device 30, then the second device 30 may transmit the play state information of “Live” to the server 20; and if the user thereafter plays the on-demand video on the second device 30, then the second device 30 may transmit the play state information of “On-Demand” to the server 20. Thus the server can determine directly from the play state information whether the video played by the second device 30 is a live video or an on-demand video.

In a third approach, the determination is made according to whether a list of programs is available.

The server 20 requests for a list of programs corresponding to the channel of the live video at the first URL network address, and if no list of programs is available, then the server 200 may determine that the video played by the second device 30 is an on-demand video; otherwise, the server 200 may determine that the video played by the second device 30 is a live video.

The list of programs is a schedule of programs of the channel of the live video corresponding to the first URL network address, where the schedule includes a segment of text including start and end times of each of the programs of the channel e.g., 9 o'clock—Boxing, 10 o'clock—News, etc.

The server 20 can retrieve the list of programs at the first URL network address of the channel of the live video, but cannot retrieve the list of programs at the first URL network address of the on-demand video.

In the operation 2, the server 20 determines whether a program of the live video lastly played by the second device 30 is terminated.

In an embodiment of the disclosure, after the first device 10 bound with the second device 30 is connected to the network, the server 20 may record automatically the time when the first device 10 is connected to the network, compare the time when the first device 10 is connected to the network with the end time of the program of the live video lastly played by the second device 30, and determine whether the program of the live video lastly played by the second device 30 is terminated when the first device 10 is connected to the network.

In order to determine whether the program is terminated, the server 20 needs to firstly determine the end time of the program of the live video corresponding to the progression information.

Optionally the server 20 determines the end time of the program corresponding to the live video played by the second device 30 according to the lastly obtained progression information of the video played by the second device 30 in such a way that the server 20 obtains a list of programs of the channel of the live video played by the second device 30, at the first URL network address, where the list of programs includes start time and end time of each of the programs of the channel; and

The server 20 determines an end time of a program corresponding to a start time and the end time between which the lastly obtained progression information of the video played by the second device 30 lies, as the end time of the program corresponding to the live video played by the second device 30.

Here the progression information, lastly obtained by the server 20, of the video played by the second device 30 is progression information, obtained by the server 20, of the video played by the second device 30 when the first device 10 is connected to the network.

If the progression information, lastly obtained by the server 20, of the video played by the second device 30 lies between the start time and the end time of a specific program, then that program may be lastly played by the second device 30, and further the end time of that program may be determined. For example, if the progression information is 9 o'clock, and the start time and the end time of the program 1 are 8 o'clock and 10 O'clock, then the program 1 may be lastly played by the second device 30, and the end time thereof may be 10 o'clock.

After the end time of the video lastly played by the second device 30 is determined, the server 20 can compare the end time with the progression information, and determine whether the live video lastly played by the second device 30 is terminated when the first device 10 is connected to the network.

In the operation 3, the server 20 transmits synchronized data of the live video to the first device 10.

The server 20 can transmit the synchronized data of the live video to the first device 10 in the following two approaches dependent upon whether the program of the live video is terminated.

In a first approach, the program is not terminated.

If the first device 10 is connected to the network earlier than the end time of the video lastly played by the second device 30, then the program is not terminated.

The server 20 retrieves the first video list at the first URL network address of the channel of the live video. The server 20 retrieves the first video list at the first URL network address which is the first URL network address corresponding to the channel of the live video played by the user on the second device 30 in the shortest interval of time from when the first device 10 is connected to the network. For example, if the first device 10 is connected to the network at 9 o'clock, and there are only the URL 1 network address corresponding to the channel of the live video watched at 8:50, and the URL 2 network address corresponding to the channel of the live video watched at 8:55 stored in the server 20, then the server 20 may transmit the URL 2 network address to the first device 10.

The server 20 updates the video play state to “Live”.

The server 20 transmits a part or all of the first video list, the first URL network address, and the video play state of “Live” to the first device 10.

In a second approach, the program is terminated.

If the first device 10 is connected to the network at or later than the end time of the program of the live video lastly played by the second device 30, then the program is terminated.

Optionally after the server 20 determines the end time of the program corresponding to the live video played by the second device 30, according to the lastly obtained progression information of the video played by the second device 30, the server 20 determines a second video list according to a second URL network address of the on-demand video of the program upon determining from the end time that the program corresponding to the live video is terminated; and

The server 20 transmits the second video list, and the lastly obtained progression information of the video played by the second device 30 to the first device 10.

The second URL network address is a network address of the on-demand video corresponding to the program of the live video. The server 20 determines the on-demand video corresponding to the program of the live video at the end of the program of the live video. The second video list is a video list of the on-demand video corresponding to the program of the live video.

After the first device 10 is connected to the network, if the server 20 determines that the live video is terminated, then the server 20 may obtain the second URL network address of the program of the live video played by the second device 30, and retrieve the second video list at the second URL network address, where the version of the video record of the program may have a different resolution corresponding to the different second URL network address. The second video list includes the URL network addresses of all the video segments in the video record of the program. The first device 10 can retrieve the data of all the video segments composing the video record at the URL network addresses of all the video segments in the video record.

The server 20 can further modify the progression information so that the real instance of time is modified to a period of time for which a segment of video is watched. For example, if the user watches a program 1 of the live video up to 9 o'clock, where the program 1 starts at 8 o'clock, then the progression information may be modified from “9 o'clock” to “1 hour”.

The server 20 updates the video play state to “On-Demand”.

The server 20 transmits to the first device 10 a part or all of:

The second video list, the second URL network address, the progression information, and the video play state of “On-Demand”.

In an embodiment of the disclosure, the first device 10 further plays the live video of the same channel, or the video record of the same program from the original progression, according to the synchronized data of the played video transmitted by the server 20 upon reception of the data.

Optionally the first device 10 in an embodiment of the disclosure can inquire the user of whether to further play the live video, or the video record of the same program. If the first device 10 determines from the synchronized data transmitted by the server 20 that the live video needs to be further played, then a small window may be popped out on the screen of the first device 10, and the live video may be played in the small window, and the user may be inquired of whether to further play the video live, and if the user accepts it, then the video may be further played live; otherwise, the small window may be switched to a control interface. If the first device 10 determines from the synchronized data transmitted by the server 20 that the on-demand video needs to be further played, then a small window may be popped out on the screen of the first device 10, and a brief video may be played in the small window, and the user may be inquired of whether to further watch the video record, and if the user accepts it, then the video record may be further played; otherwise, the small window may be switched to a control interface. The brief video can be a segment of video for a period of time picked out from the program.

Optionally if the live program is terminated, then the first device 10 can select a video record of the same program with a resolution appropriate for the network speed, and the resolution of the display device for further playing.

The resolutions of the screen of the first device 10 and the second device 30 of the user are typically different. For example, the second device 30 is a mobile phone, and the first device 10 is a high-definition TV set. The resolution, can be selected in the following two approaches.

In a first approach, a higher resolution is selected.

The user watches the video record on the first device 10 with a high definition (the live video can not be further watched, and the resolution of the live video is fixed) after watching the live video on the second device 30 with a low definition, where the first device 10 can select the video with a higher resolution according to the network speed.

For example, if the second device 30 is a mobile phone, and the first device 10 is a TV set with a large screen, where the live video is watched on the mobile phone with a resolution of typically 480p; and the first device 10 can retrieve the video records with resolutions of 480p and 720p from the server 20, and the network speed is 10 M, then the first device 10 can request and further play the video record of 720p from the server 20.

In a second approach, a lower resolution is selected.

The user watches the video record on the first device 10 with a low definition (the live video can not be further watched, and the resolution of the live video is fixed) after watching the live video on the second device 30 with a high definition, where the first device 10 can select the video with a lower resolution according to the network speed.

For example, if the second device 30 is a TV set with a large screen, and the first device 10 is a mobile phone, where the live video is watched on the mobile phone with a resolution of typically 720p; and the first device 10 can retrieve the video records with resolutions of 480p and 720p from the server 20, and the user accesses the Internet by consuming data traffic, then the first device 10 can request and further play the video record of 480p from the server 20.

As illustrated in FIG. 2, an embodiment of the disclosure provides a first apparatus for synchronizing data, where the first apparatus includes:

A time determining module 201 is configured, upon determining that a video played by a second device bound with a first device is a live video, to determine an end time of a program corresponding to the live video played by the second device, according to lastly determined progression information of the video played by the second device; and

A transmitting module 202 is configured to transmit a first URL network address corresponding to a channel of the live video to the first device upon determining from the end time that the program corresponding to the live video is not terminated.

In an embodiment of the disclosure, the relevant functional modules are embodied by a hardware processor.

The first device and the second device in the embodiment of the disclosure are display devices on which a network video can be watched, or devices which are used to watch a network video together with a display device, e.g., a mobile phone, a Wi-Fi enabled tablet computer, a computer, a smart TV set, or a TV box. The first device 10 and the second device 30 can be the same type of devices. For example, if the first device 10 is a mobile phone, then the second device 30 may also be a mobile phone. The first device 10 and the second device 30 can alternatively be different types of devices. For example, the first device 10 is a mobile phone, and the second device 30 is a TV set.

The first device and the second device can be bound in the following two approaches without any limitation thereto.

In a first approach, they log into the same account.

If the time determining module 201 determines that the first device and the second device log into the same account in the same or associated video applications, then the time determining module 201 may bind the first device with the second device.

For example, if the time determining module 201 determines that the second device logs into an account 1, and further determines that the first device logs into the account 1, then the time determining module 201 may bind the first device with the second device.

In a second approach, their physical addresses are associated with the same account.

The time determining module 201 stores physical addresses of the first device and the second device which have logged into the same account of the same video application, and binds the first device with the second device.

For example, if the time determining module 201 determines that the first device has logged into an account 1 of a video application, a user transmits a message to the time determining module 201 to associate an MAC address of the first device with the account 1, and the second device logs into the account 1, then the time determining module 201 may bind the MAC address of the first device with the second device.

In an embodiment of the disclosure, before played video data of the second device and the first device are synchronized, the second device plays an on-demand video or a live video, and transmits the data of the played video to the time determining module 201. The data of the played video transmitted by the second device can include but will not be limited to play state information, a general URL network address (i.e., the first URL network address) of the video, and the progression information.

The play state information indicates whether the video played by the second device is a live video or an on-demand video. The second device transmits the play state information in real time to the time determining module 201 according to the type of the video watched by the user in the second device. For example, if the user watches an on-demand video on the second device, then fee second device may transmit the play state information of “On-Demand” automatically to the time determining module 201, and the play state information stored in the time determining module 201 may be “On-Demand”; and if the user subsequently watches a live video on the second device, then the second device may transmit the play state information of “Live” automatically to the time determining module 201, and the play state information stored in the time determining module 201 may be “Live”.

The first URL network address refers to a network address of a channel of the live video, or a network address of the on-demand video, played by the second device. The first device and the second device can retrieve the live video of the channel, or the on-demand video, corresponding to the first URL network address from the transmitting module 202 through the first URL network address. The first URL network address of the channel of the live video, or the on-demand video is fixed, so the first device and the second device can watch the live video of the same channel, or the same on-demand video from the transmitting module 202 using the same first URL network address.

The user can select a live video of a channel on the second device to thereby select a first URL network address, and send the first URL network address to the time determining module 201. For example, the user can select a “Life Channel” on the mobile phone, and since the “Life Channel” corresponds to a first URL network address, the user selects the “Life Channel” so that the first URL network address corresponding to the “Life Channel” is transmitted to the time determining module 201.

The user can alternatively select an on-demand video on the second device to thereby select a first URL network address, and send the first URL network address to the time determining module 201. For example, the user can select a “Comedy” on the mobile phone, and since the “Comedy” corresponds to a first URL network address, the user selects the “Comedy” so that the first URL network address corresponding to the “Comedy” is transmitted to the time determining module 201.

After the user plays a live video of a channel, or an on-demand video on the second device, the second device may transmit a first URL network address to the time determining module 201.

The progression information can indicate a real instance of time of the live video being watched, or a progression of the on-demand video being watched. For example, if the second device plays the on-demand video, then the second device may play it up to the 40^{th} minute so that the progression information is 40 minutes; and if the second device plays the live video, then the second device may play it up to 9 o'clock so that the progression information is 9 o'clock.

The second device transmits the heartbeat information periodically to the time determining module 201 to update the progression information while playing the live video. The time determining module 201 determines an instance of time when the heartbeat information is received, as progression information to replace the original progression information. For example, if the server time determining module 201 receives the heartbeat information transmitted by the second device at 9 o'clock, then the progression information may be updated to “9 o'clock”, and if the time determining module 201 thereafter further receives the heartbeat information transmitted by the second device at 9:20, then the progression information may be updated to “9:20”. If the second device playing the on-demand video closes the video application, then the second device may transmit the last progression information of the on-demand video being played to the time determining module 201. For example, if the second device playing the on-demand video up to the 40^{th} minute closes the video application, then the second device may transmit the progression information of “40 Minutes” to the time determining module 201.

After the first device bound with the second device is connected to the network, the transmitting module 202 may synchronize the data of the video played by the first device to the first device in the following several operations.

In the operation 1, the time determining module 201 determines whether the video played by the second device is a live video.

The time determining module 201 determines whether the video watched on the second device is a live video or an on-demand video before the first device 0 is connected to the network (or logs into the same account as the second device).

Optionally the time determining module 201 determines whether the video played by the second device is a live video, in the following three approaches.

In a first approach, the determination is made according to a video list.

The time determining module 201 determines a first video list according to the first URL network address corresponding to the video played by the second device bound with the first device; and determines whether there is an end flag in the first video list; and if so, then the time determining module 201 may determine that the video played by the second device is an on-demand video; otherwise, the time determining module 201 may determine that the video played by the second device is a live video.

The first video list can be a segment of text, and can be retrieved by the time determining module 201 at the first URL network address corresponding to the channel of the live video, or the first URL network address corresponding to the on-demand video. The first video list includes URL network addresses of video segments of the played video. A URL network address of a video segment represents a network address corresponding to a particular segment of video, and the first video list of the live video or the on-demand video can be consisted of a plurality of URL network addresses of video segments. A URL network address of a video segment includes a filename of the video segment, and the end of the filename can include a number so that the display device can retrieve and play the files of the video segments from the time determining module 201 in an ascending order of their numbers. For example, if a URL 1 network address of a video segment in the first video list includes a filename “f1” of the video segment, and a URL 2 network address of a video segment in the first video list includes a filename “F2” of the video segment then the display device will may play the video segment corresponding to the network address URL 1.

The video list of the live video includes a URL network address of a video segment being played, and URL network addresses of several video segments to be played. The number in a filename included in the URL network address of the video segment being played is the least. The video list of the live video is updated constantly by removing the URL network addresses of the video segments which have been played, and adding URL network addresses of video segments buffered and downloaded from the time determining module 201. For example, the first video list includes “URL 1 Network Address of Video Segment, URL 2 Network Address of Video Segment, and URL 3 Network Address of Video Segment” at 9 o'clock, and the first video list is updated to include “URL 2 Network Address of Video Segment, URL 3 Network Address of Video Segment, and URL 4 Network Address of Video Segment” at 9:05.

In a real application, the first device and the second device going to play the live video need to download the latest first video list periodically at the first URL network address, and download the segments of the video from the transmitting module 202 at the URL network addresses of the video segments in the first video list. Thus the transmitting module 202 needs to provide the first device with the first URL network address corresponding to the channel of the live video played by the second device so that the first device can play the live video of the same channel as the second device.

The video list of the on-demand video includes the URL network addresses of all the video segments composing the on-demand video. Thus the second device may not update the video list of the on-demand video after downloading it from the transmitting module 202.

In a real application, the first device and the second device going to play the on-demand video download the latest first video list at the first URL network address, and determine a video segment corresponding to a URL network address of the video segment that they request for downloading from the transmitting module 202, according to the progression information of the on-demand video being played in the first device and the second device. For example, if the on-demand video is played up to the 30^{th} minute in the second device, a URL 10 network address of a video segment corresponds to the video segment from the 30^{th} to 31^{st} minutes of the on-demand video, and a URL 11 network address of a video segment corresponds to the video segment from the 31^{st} to 32^{nd} minutes of the on-demand video, then the second device going to further play the on-demand video may firstly download the video segment from the 30^{th} to 31^{st} minutes of the on-demand video at the URL 10 network address of the video segment, and then pre-download the video segment from the 31^{st} to 32^{nd} minutes of the on-demand video corresponding to the URL 11 network address of the video segment, so that the second device can play the video segment from the 31^{st} to 32^{nd} minutes of the on-demand video smoothly following the video segment of the 30^{th} to 31^{st} minutes of the on-demand video.

The first video list of the live video is different from the first video list of the on-demand video in that there is no end flag (e.g., END) in the first video list of the live video, and there is an end flag in the first video list of the on-demand video. Thus it can be determined whether the video played by the second device is a live video, by determining whether there is an end flag in the first video list. For example, the first video list of the live video includes URL 1 Network Address of Video Segment, URL 2 Network Address of Video Segment, and URL 3 Network Address of Video Segment; and the first video list of the on-demand video includes URL 1 Network Address of Video Segment, URL 2 Network Address of Video Segment, URL 3 Network Address of Video Segment, and END.

In a second approach, the determination is made according to the play state information.

The time determining module 201 determines whether the video played by the second device is a live video, according to the play state information from the second device.

When the second device plays the live video or the on-demand video, the second device may transmit the play state information to the time determining module 201. The play state information can be a text, or can be a number representing “Live” or “On-Demand”. For example, if the user plays the live video on the second device, then the second device may transmit the play state information of “Live” to the time determining module 201; and if the user thereafter plays the on-demand video on the second device, then the second device may transmit the play state information of “On-Demand” to the time determining module 201. Thus the time determining module 201 can determine directly from the play state information whether the video played by the second device is a live video or an on-demand video.

In a third approach, the determination is made according to whether a list of programs is available.

The time determining module 201 requests for a list of programs corresponding to the channel of the live video at the first URL network address, and if no list of programs is available, then the time determining module 201 may determine that the video played by the second device is an on-demand video; otherwise, the time determining module 201 may determine that the video played by the second device is a live video.

The list of programs is a schedule of programs of the channel of the live video corresponding to the first URL network address, where the schedule includes a segment of text including start and end times of the each of the programs of the channel, e.g., 9 o'clock—Boxing, 10 o'clock—News, etc.

The time determining module 201 can retrieve the list of programs at the first URL network address of the channel of the live video, but cannot retrieve the list of programs at the first URL network address of the on-demand video.

In the operation 2, the transmitting module 202 determines whether a program of the live video lastly played by the second device is terminated.

In an embodiment of the disclosure, after the first device bound with the second device is connected to the network, the time determining module 201 may record automatically the time when the first device is connected to the network, compare the time when the first device is connected to the network with the end time of the program of the live video lastly played by the second device, and determine whether the program of the live video lastly played by the second device is terminated when the first device is connected to the network.

In order to determine whether the program is terminated, the time determining module 201 needs to firstly determine the end time of the program of the live video corresponding to the progression information.

Optionally the time determining module 201 determines the end time of the program corresponding to the live video played by the second device according to the lastly obtained progression information of the video played by the second device in such a way that the time determining module 201 obtains a list of programs of the channel of the live video played by the second device, at the first URL network address, where the list of programs includes start time and end time of each of the programs of the channel; and

The time determining module 201 determines an end time of a program corresponding to a start time and the end time between which the lastly obtained progression information of the video played by the second device lies, as the end time of the program corresponding to the live video played by the second device.

Here the progression information, lastly obtained by the time determining module 201, of the video played by the second device is progression information, obtained by the time determining module 201, of the video played by the second device when the first device is connected to the network.

If the progression information, lastly obtained by the time determining module 201, of the video played by the second device lies between the start time and the end time of a specific-program, then that program may be lastly played by the second device, and further the end time of that program may be determined. For example, if the progression information is 9 o'clock, and the start time and the end time of the program 1 are 8 o'clock and 10 o'clock, then the program 1 may be lastly played by the second device, and the end time thereof may be 10 o'clock.

After the end time of the video lastly played by the second device is determined, the time determining module 201 can compare the end time with the progression information, and determine whether the live video lastly played by the second device is terminated when the first device is connected to the network.

In the operation 3, the transmitting module 202 transmits synchronized data of the live video to the first device.

The transmitting module 202 can transmit the synchronized data of the live video to the first device in the following two approaches dependent upon whether the program of the live video is terminated.

In a first approach, the program is not terminated.

If the first device is connected to the network earlier than the end time of the live video lastly played by the second device, then the program is not terminated.

The transmitting module 202 retrieves the first video list at the first URL network address of the channel of the live video. The transmitting module 202 retrieves the first video list at the first URL network address which is the first URL network address corresponding to the channel of the live video played by the user on the second device in the shortest interval of time from when the first device is connected to the network. For example, if the first device is connected to the network at 9 o'clock, and there are only the URL 1 network address corresponding to the channel of the live video watched at 8:50, and the URL 2 network address corresponding to the channel of the live video watched at 8:55 stored in the transmitting module 202, then the transmitting module 202 may transmit the URL 2 network address to the first device.

The transmitting module 202 updates the video play state to “Live”.

The transmitting module 202 transmits a part or all of the first video list, the first URL network address, and the video play state of “Live” to the first device.

In a second approach, the program is terminated.

If the first device is connected to the network at or later than the end time of the program of the live video lastly played by the second device, then the program is terminated.

Optionally after the time determining module 201 determines the end time of the program corresponding to the live video played by the second device, according to the lastly obtained progression information of the video played by the second device, the time determining module 201 determines a second video list according to a second URL network address of the on-demand video of the program upon determining from the end time that the program corresponding to the live video is terminated; and

The transmitting module 202 transmits the second video list, and the lastly obtained progression information of the video played by the second device to the first device.

The second URL network address is a network address of the on-demand video corresponding to the program of the live video. The transmitting module 202 determines the on-demand video corresponding to the program of the live video at the end of the program of the live video. The second video list is a video list of the on-demand video corresponding to the program of the live video.

After the first device is connected to the network, if the transmitting module 202 determines that the live video is terminated, then the transmitting module 202 may obtain the second URL network address of the program of the live video played by the second device, and retrieve the second video list at the second URL network address, where versions of the video record of the program may have different resolutions corresponding to different second URL network addresses. The second video list includes URL network addresses of all the video segments in the video record of the program. The first device can retrieve the data of all the video segments composing the video record at the URL network addresses of all the video segments in the video record.

The transmitting module 202 can further modify the progression information so that the real instance of time is modified to a period of time for which a segment of video is watched. For example, if the user watches a program 1 of the live video up to 9 o'clock, where the program 1 starts at 8 o'clock, then the progression information may be modified from “9 o'clock” to “1 hour”.

The transmitting module 202 updates the video play state to “On-Demand”.

The transmitting module 202 transmits to the first device a part or all of:

The second video list, the second URL network address, the progression information, and the video play state of “On-Demand”.

In an embodiment of the disclosure, the first device further plays the live video of the same channel, or the video record of the same program from the original progression, according so the synchronized data of the played video transmitted by the transmitting module 202 upon reception of the data.

Optionally the first device in an embodiment of the disclosure can inquire the user of whether to further play the live video, or the video record of the same program. If the first device determines from the synchronized data transmitted by the transmitting module 202 that the live video needs to be further played, then a small window may be popped out on the screen of the first device, and the live video may be played to the small window, and the user may be inquired of whether to further play the video live, and if the user accepts if, then the video may be further played live; otherwise, the small window may be switched to a control interface. If the first device determines from the synchronized data transmitted by the transmitting module 202 that the on-demand video needs to be further played, then a small window may be popped out on the screen of the first device, and a brief video may be played in the small window, and the user may be inquired of whether to further watch the video record, and if the user accepts it, then the video record may be further played; otherwise, the small window may be switched to a control interface. The brief video can be a segment of video for a period of time picked out from the program.

Optionally if the live program is terminated, then the first device can select a video record of the same program with a resolution appropriate for the network speed, and the resolution of the display device for further playing.

The resolutions of the screen of the first device and the second device of the user are typically different. For example, the second device is a mobile phone, and the first device is a high-definition TV set. The resolution can be selected in the following two approaches.

In a first approach, a higher resolution is selected.

The user watches the video record on the first device with a high definition (the live video can not be further watched, and the resolution of the live video is fixed) after watching the live video on the second device with a low definition, where the first device can select the video with a higher resolution according to the network speed.

For example, if the second device is a mobile phone, and the first device is a TV set with a large screen, where the live video is watched on the mobile phone with a resolution of typically 480p; and the first device can retrieve the video records with resolutions of 480p and 720p from the transmitting module 202, and the network speed is 10 M, then the first device can request and further play the video record of 720p from the transmitting module 202.

In a second approach, a lower resolution is selected.

The user watches the video record on the first device with a low definition (the live video can not be further watched, and the resolution of the live video is fixed) after watching the live video on the second device with a high definition, where the first device can select the video with a lower resolution according to the network speed.

For example, if the second device is a TV set with a large screen, and the first device is a mobile phone, where the live video is watched on the mobile phone with a resolution of typically 720p; and the first device can retrieve the video records with resolutions of 480p and 720p from the transmitting module 202, and the user accesses the Internet by consuming data traffic, then the first device can request and further play the video record of 480p from the transmitting module 202.

Optionally the time determining module 201 is configured:

To determine a first video list according to the first URL network address corresponding to the video played by the second device bound with the first device; and to determine whether there is an end flag in the first video list; and if so, to determine that the video played by the second device is an on-demand video; otherwise, to determine that the video played by the second device is a live video; or

To determine whether a list of programs is available, and if no list of programs is available, to determine that the video played by the second device is an on-demand video; otherwise, to determine that the video played by the second device is a live video.

Optionally the transmitting module 202 is configured:

To retrieve the latest video list periodically from a live video server corresponding to the first URL network address; and

To determine the retrieved latest video list as the first video list.

Optionally the time determining module 201 is configured:

To obtain a list of programs of the channel of the live video played by the second device, at the first URL network address, where the list of programs includes start time and end time of each of the programs of the channel; and

To determine an end time of a program corresponding to a start time and the end time between which the lastly obtained progression information of the video played by the second device lies, as the end time of the program corresponding to the live video played by the second device.

Optionally the transmitting module 202 is further configured:

To determine a second video list according to a second URL network address of the on-demand video of the program upon determining from the end time that the program corresponding to the live video is terminated; and

To transmit the second video list, and the lastly obtained progression information of the video played by the second device to the first device.

Optionally the time determining module 201 is configured:

To receive heartbeat information transmitted by the second device while the second device is playing the live video; and

To determine the progression information of the video being played by the second device, according to the heartbeat information each time the heartbeat information is received.

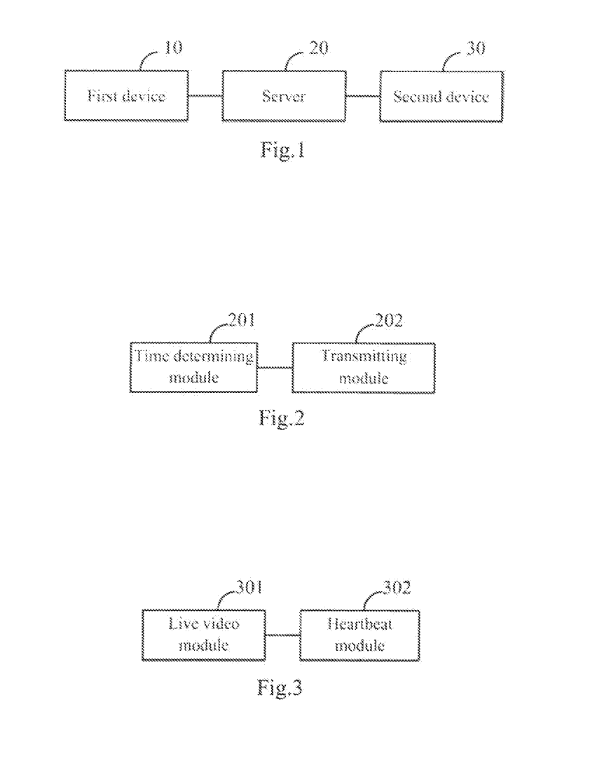

As illustrated in FIG. 3, an embodiment of the disclosure provides a second apparatus for synchronizing data, the apparatus including:

A live video module 301 is configured to play a live video; and

A heartbeat module 302 is configured to transmit heartbeat information periodically to a server while the live video is being played, so that the server determines an end time of a program corresponding to the live video played by a second device, according to lastly determined progression information of the video played by the second device, and transmits a first video list to a first device upon determining from the end time that the program corresponding to the live video is not terminated.

In an embodiment of the disclosure, the relevant functional modules are embodied by a hardware processor.

Based upon the same inventive idea, embodiments of the disclosure further provide methods for synchronizing data, and since devices corresponding to these methods are the devices according to the embodiments of the disclosure, and these devices address the problem under a similar principle to the devices according to the embodiments of the disclosure, reference can be made for the implementations of the devices for implementations of these methods, so a repeated description thereof may be omitted here.

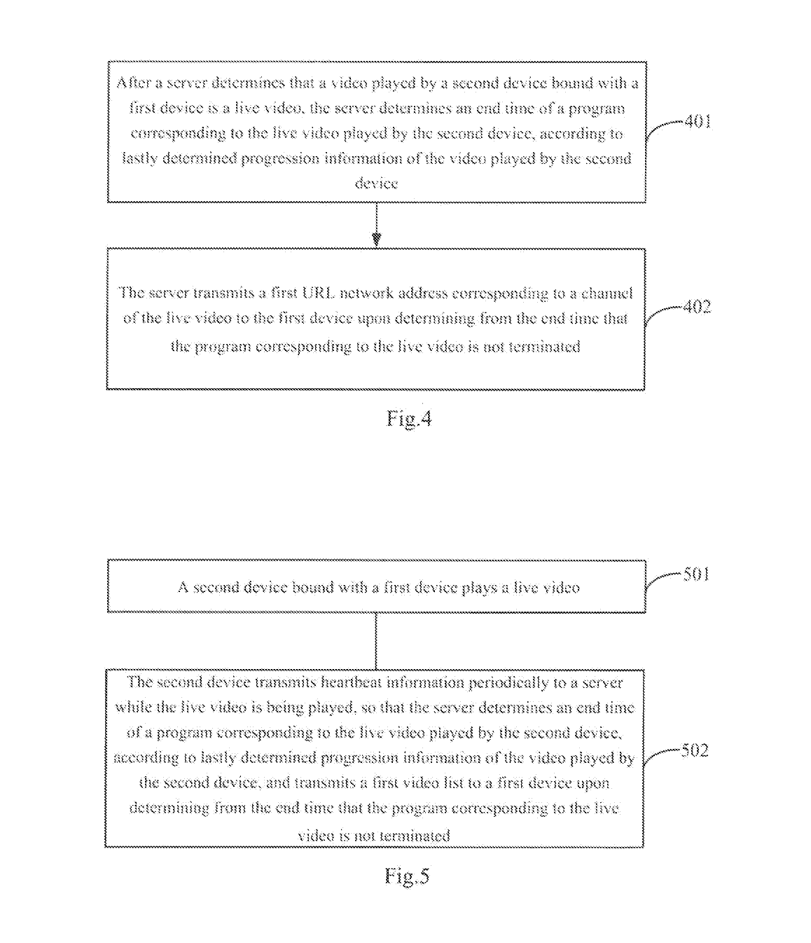

As illustrated in FIG. 4, an embodiment of the disclosure provides a first method for synchronizing data, where the method includes:

In the operation 401, after a server-determines that a video played by a second device bound with a first device is a live video, the server determines an end time of a program corresponding to the live video played by the second device, according to lastly determined progression information of the video played by the second device; and

In the operation 402, the server transmits a first URL network address corresponding to a channel of the live video to the first device upon determining from the end time that the program corresponding to the live video is not terminated.

Optionally the server determines whether the video played by the second device is a live video, as follows:

The server determines a first video list according to the first URL network address corresponding to the video played by the second device bound with the first device; and determines whether there is an end flag in the first video list; and if so, then the server may determine that the video played by the second device is an on-demand video; otherwise, the server may determine that the video played by the second device is a live video; or

The server determines that the video played by the second device is a live video, according to play state information from the second device; or

The server requests for a list of programs at the first URL network address, and if no list of programs is available, then the server may determine that the video played by the second device is an on-demand video; otherwise, the server may determine that the video played by the second device is a live video.

Optionally the server determines the first video list corresponding to the live video in the following operations:

The server retrieves the latest video list periodically from a live video server corresponding to the first URL network address; and

The server determines the retrieved latest video list as the first video list.

Optionally the server determines the end time of the program corresponding to the live video played by the second device, according to the lastly determined progression information of the video played by the second device as follows:

The server obtains a list of programs of the channel of the live video played by the second device, according to the first URL network address, where the list of programs includes start time and end time of each of the programs of the channel; and

The server determines an end time of a program corresponding to a start time and the end time between which the lastly obtained progression information of the video played by the second device lies, as the end time of the program corresponding to the live video played by the second device.

Optionally after the server determines the end time of the program corresponding to the live video played by the second device, according to the lastly determined progression information of the video played by the second device, the method further includes:

The server determines a second video list according to a second URL network address of the on-demand video of the program upon determining from the end time that the program corresponding to the live video is terminated; and

The server transmits the second video list, and the lastly obtained progression information of the video played by the second device to the first device.

Optionally the server determines the progression information of the video played by the second device as follows:

The server receives heartbeat information transmitted by the second device while the second device is playing the live video; and

The server determines the progression information of the video being played by the second device, according to the heartbeat information each time the heartbeat information is received.

As illustrated in FIG. 5, an embodiment of the disclosure provides a second method for synchronizing data, where the method includes:

In the operation 501, a second device bound with a first device plays a live video; and

In the operation 502, the second device transmits heartbeat information periodically to a server while the live video is being played, so that the server determines an end time of a program corresponding to the live video played by the second device, according to lastly determined progression information of the video played by the second device, and transmits a first video list to a first device upon determining from the end time that the program corresponding to the live video is not terminated.

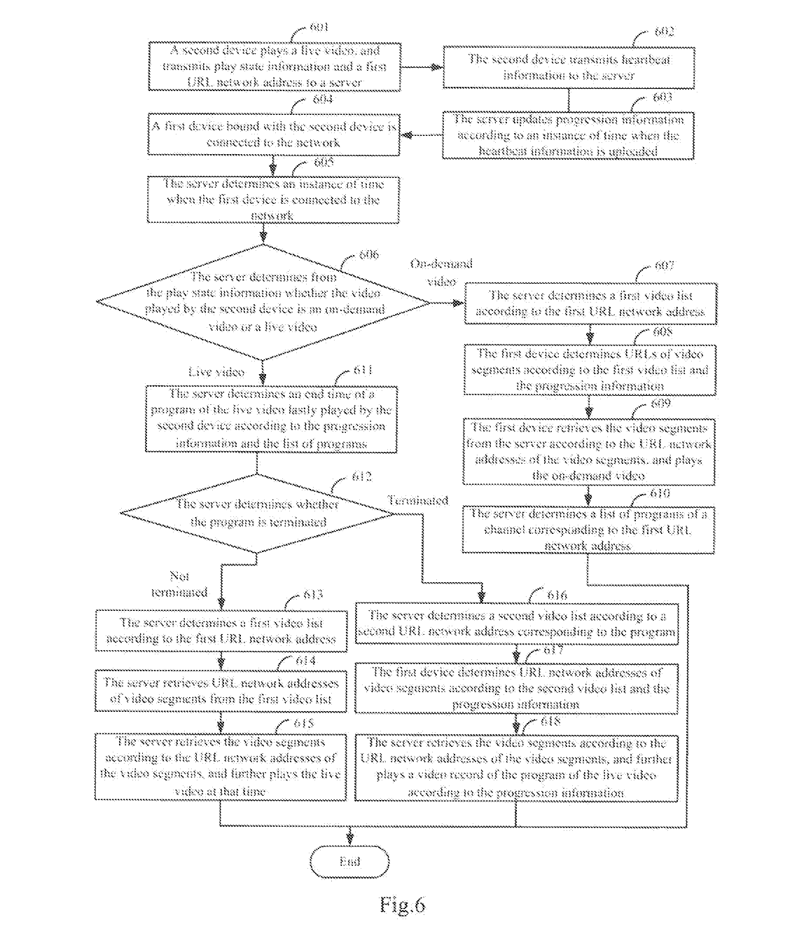

As illustrated in FIG. 6, a general flow of a method for synchronizing data according to an embodiment of the disclosure includes the following operations:

In the embodiment of the disclosure, the operation 602 and the operation 603 are performed repeatedly while a second device is playing a live video, until the second device stops the live video from being played.

In the operation 601, a second device plays a live video, and transmits play state information and a first URL network address to a server;

In the operation 602, the second device transmits heartbeat information to the server;

In the operation 603, the server updates progression information according to an instance of time when the heartbeat information is uploaded;

In the operation 604, a first device bound with the second device is connected to the network;

In the operation 605, the server determines an instance of time when the first device is connected to the network;

In the operation 606, the server determines from the play state information whether the video played by the second device is an on-demand video or a live video, and if the video is an on-demand video, then the server may proceed to the operation 607; or if the video is a live video, then the server may proceed to the operation 611;

In the operation 607, the server determines a first video list according to the first URL network address;

In the operation 608, the first device determines URLs of video segments according to the first video list and the progression information;

In the operation 609, the first device retrieves the video segments from the server according to the URL network addresses of the video segments, and plays the on-demand video;

In the operation 610, the server determines a list of programs of a channel corresponding to the first URL network address;

In the operation 611, the server determines an end time of a program of the live video lastly played by the second device according to the progression information and the list of programs;

In the operation 612, the server determines whether the program is terminated, and if not, then the server may proceed to the operation 613; otherwise, the server may proceed to the operation 616;

In the operation 613, the server determines a first video list according to the first URL network address;

In the operation 614, the server retrieves URL network addresses of video segments according to the first video list;

In the operation 615, the server retrieves the video segments according to the URL network addresses of the video segments, and further plays the live video at that time;

In the operation 616, the server determines a second video list according to a second URL network address corresponding to the program;

In the operation 617, the first device determines URL network addresses of video segments according to the second video list and the progression information; and

In the operation 618, the server retrieves the video segments according to the URL network addresses of the video segments, and further plays a video record of the program of the live video according to the progression information.

As can be apparent from the disclosure, after the server in the embodiments of the disclosure determines that the video played by the second device bound with the first device is a live video, the server determines the end time of the program corresponding to the live video played by the second device, according to the lastly determined progression information of the video played by the second device; and the server transmits the first URL network address corresponding to the channel of the live video to the first device upon determining from the end time that the program corresponding to the live video is not terminated. Since the first video list corresponding to the live video played in the second device can be transmitted to the first device in the embodiments of the disclosure, the first device can play the same live video as in the second video device according to the first video list.

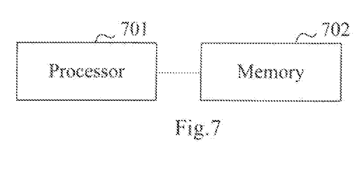

Based upon the same inventive idea, an embodiment of the disclosure further provides an electronic device for synchronizing data, as illustrated in FIG. 7, which includes:

At least one processor 701 and a memory 702, where there is one processor as an example in FIG. 7.

The memory 702 is communicably connected with the at least one processor for storing instructions executable by the at least one processor, wherein execution of the instructions by the at least one processor causes the at least one processor to:

Upon determining that a video played by a second device bound with a first device is a live video, determine an end time of a program corresponding to the live video played by the second device, according to lastly determined progression information of the video played by the second device; and

Transmit a first URL network address corresponding to a channel of the live video to the first device upon determining from the end time that the program corresponding to the live video is not terminated.

In one embodiment, the execution of the instructions by the at least one processor further causes the at least one processor to:

Determine a first video list according to the first URL network address corresponding to the video played by the second device bound with the first device; and determine whether there is an end flag in the first video list; and if so, determine that the video played by the second device is an on-demand video; otherwise, determine that the video played by the second device is a live video; or

Determine whether the video played by the second device is a live video, according to play state information from the second device; or

Request for a list of programs at the first URL network address, and if no list of programs is available, determine that the video played by the second device is an on-demand video; otherwise, determine the video played by the second device is a live video.

In one embodiment, the execution of the instructions by the at least one processor further causes the at least one processor to:

Retrieve the latest video list periodically from a live video server corresponding to the first URL network address; and

Determine the retrieved latest video list as the first video list.

In one embodiment, the execution of the instructions by the at least one processor further causes the at least one processor to:

Obtain a list of programs of the channel of the live video played by the second device, according to the first URL network address, wherein the list of programs comprises start time and end time of each of the programs of the channel; and

Determine an end time of a program corresponding to a start time and the end time between which the lastly obtained progression information of the video played by the second device lies, as the end time of the program corresponding to the live video played by the second device.

In one embodiment, the execution of the instructions by the at least one processor further causes the at least one processor to;

Determine a second video list according to a second URL network address of the on-demand video of the program upon determining from the end time that the program corresponding to the live video is terminated; and

Transmit the second video list, and the lastly obtained progression information of the video played by the second device to the first device.

In one embodiment, the execution of the instructions by the at least one processor further causes the at least one processor to:

Receive heartbeat information transmitted by the second device while the second device is playing the live video; and

Determine the progression information of the video being played by the second device, according to the heartbeat information each time the heartbeat information is received.

Based upon the same inventive idea, an embodiment of the disclosure further provides a non-transitory computer-readable storage medium storing executable instructions that, when executed by an electronic device, cause the electronic device to:

Upon determining that a video played by a second device bound with a first device is a live video, determine an end time of a program corresponding to the live video played by the second device, according to lastly determined progression information of the video played by the second device; and

Transmit a first URL network address corresponding to a channel of the live video to the first device upon determining from the end time that the program corresponding to the live video is not terminated.

In one embodiment, the executable instructions executed by the electronic device further cause the electronic device to:

Determine a first video list according to the first URL network address corresponding to the video played by the second device bound with the first device; and determine whether there is an end flag in the first video list; and if so, determine that the video played by the second device is an on-demand video; otherwise, determine that the video played by the second device is a live video; or

Determine whether the video played by the second device is a live video, according to play state information from the second device; or

Request for a list of programs at the first URL network address, and if no list of programs is available, determine that the video played by the second device is an on-demand video; otherwise, determine the video played by the second device is a live video.

In one embodiment, the executable instructions executed by the electronic device further cause the electronic device to:

Retrieve the latest video list periodically from a live video server corresponding to the first URL network address; and

Determine the retrieved latest video list as the first video list.

In one embodiment, the executable instructions executed by the electronic device further cause the electronic device to:

Obtain a list of programs of the channel of the live video played by the second device, according to the first URL network address, wherein the list of programs comprises start time and end time of each of the programs of the channel; and

Determine an end time of a program corresponding to a start time and the end time between which the lastly obtained progression information of the video played by the second device lies, as the end time of the program corresponding to the live video played by the second device.

In one embodiment, the executable instructions executed by the electronic device further cause the electronic device to:

Determine a second video list according to a second URL network address of the on-demand video of the program upon determining from the end time that the program corresponding to the live video is terminated; and

Transmit the second video list, and the lastly obtained progression information of the video played by the second device to the first device.

In one embodiment, the executable instructions executed by the electronic device further cause the electronic device to:

Receive heartbeat information transmitted by the second device while the second device is playing the live video; and

Determine the progression information of the video being played by the second device, according to the heartbeat information each time the heartbeat information is received. The aforementioned electronic device can execute the method according to some embodiments of the disclosure, and has functional modules for executing corresponding method and advantageous thereof. For more technical details, the method according to some embodiments of the disclosure can be referred.

The electronic device according to some embodiments of the disclosure can be in multiple forms, which include but not limit to:

1. Mobile communication device, of which characteristic has mobile communication function, and briefly acts to provide voice and data communication. These terminals include smart pone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. IPod), handheld game player, electronic book, hobby robot and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof, and these modifications or substitutions to the corresponding technical solution shall also fall into the scope of the disclosure as claimed.

What is claimed is:

1. A method for synchronizing data, the method comprising:
upon determining that a video played by a second device bound with a first device is a live video, determining, by a server, an end time of a program corresponding to the live video played by the second device, according to lastly determined progression information of the video played by the second device; and
transmitting, by the server, a first Uniform Resource Locator (URL) network address corresponding to a channel of the live video to the first device upon determining from the end time that the program corresponding to the live video is not terminated.

2. The method according to claim 1, wherein determining, by the server, whether the video played by the second device is a live video comprises:
determining, by the server, a first video list according to the first URL network address corresponding to the video played by the second device bound with the first device; and determining whether there is an end flag in the first video list; and if so, then determining that the video played by the second device is an on-demand video; otherwise, determining that the video played by the second device is a live video; or
determining, by the server, whether the video played by the second device is a live video, according to play state information from the second device; or
requesting, by the server, for a list of programs at the first URL network address, and if no list of programs is available, then determining that the video played by the second device is an on-demand video; otherwise, determining that the video played by the second device is a live video.

3. The method according to claim 1, wherein determining, by the server, the first video list corresponding to the live video in the following operations:
retrieving, by the server, the latest video list periodically from a live video server corresponding to the first URL network address; and
determining, by the server, the retrieved latest video list as the first video list.

4. The method according to claim 1, wherein determining, by the server, the end time of the program corresponding to the live video played by the second devise, according to the lastly determined progression information of the video played by the second device comprises:
obtaining, by the server, a list of programs of the channel of the live video played by the second device, according to the first URL network address, wherein the list of programs comprises start time and end time of each of the programs of the channel; and
determining, by the server, an end time of a program corresponding to a start time and the end time between which the lastly obtained progression information of the video played by the second device lies, as the end time of the program corresponding to the live video played by the second device.

5. The method according to claim 1, wherein after the server determines the end time of the program corresponding to the live video played by the second device, according to the lastly determined progression information of the video played by the second device, the method further comprises:
determining, by the server, a second video list according to a second URL network address of the on-demand video of the program upon determining from the end time that the program corresponding to the live video is terminated; and
transmitting, by the server, the second video list, and the lastly obtained progression information of the video played by the second device to the first device.

6. The method according to claim 1, wherein determining, by the server, the progression information of the video played by the second device comprises:
receiving, by the server, heartbeat information transmitted by the second device while the second device is playing the live video; and
determining, by the server, the progression information of the video being played by the second device, according to the heartbeat information each time the heartbeat information is received.

7. An electronic device, comprising:
at least one processor; and
a memory communicably connected with the at least one processor for storing instructions executable by the at least one processor, wherein execution of the instructions by the at least one processor causes the at least one processor to:
upon determining that a video played by a second device bound with a first device is a live video, determine an end time of a program corresponding to the live video played by the second device, according to lastly determined progression information of the video played by the second device; and
transmit a first URL network address corresponding to a channel of the live video to the first device upon determining from the end time that the program corresponding to the live video is not terminated.

8. The electronic device according to claim 7, wherein the execution of the instructions by the at least one processor further causes the at least one processor to:
determine a first video list according to the first URL network address corresponding to the video played by the second device bound with the first device; and determine whether there is an end flag in the first video list; and if so, determine that the video played by the second device is an on-demand video; otherwise, determine that the video played by the second device is a live video; or
determine whether the video played by the second device is a live video, according to play state information from the second device; or
request for a list of programs at the first URL network address, and if no list of programs is available, determine that the video played by the second device is an on-demand video; otherwise, determine the video played by the second device is a live video.

9. The electronic device according to claim 7, wherein the execution of the instructions by the at least one processor further causes the at least one processor to:
retrieve the latest video list periodically from a live video server corresponding to the first URL network address; and
determine the retrieved latest video list as the first video list.

10. The electronic device according to claim 7, wherein the execution of the instructions by the at least one processor further causes the at least one processor to:
obtain a list of programs of the channel of the live video played by the second device, according to the first URL network address, wherein the list of programs comprises start time and end time of each of the programs of the channel; and
determine an end time of a program corresponding to a start time and the end time between which the lastly obtained progression information of the video played by the second device lies, as the end time of the program corresponding to the live video played by the second device.

11. The electronic device according to claim 7, wherein the execution of the instructions by the at least one processor further causes the at least one processor to:
determine a second video list according to a second URL network address of the on-demand video of the program upon determining from the end time that the program corresponding to the live video is terminated; and
transmit the second video list, and the lastly obtained progression information of the video played by the second device to the first device.

12. The electronic device according to claim 7, wherein the execution of the instructions by the at least one processor further causes the at least one processor to:
receive heartbeat information transmitted by the second device while the second device is playing the live video; and
determine the progression information of the video being played by the second device, according to the heartbeat information each time the heartbeat information is received.

13. A non-transitory computer-readable storage medium storing executable instructions that, when executed by an electronic device, cause the electronic device to:
upon determining that a video played by a second device bound with a first device is a live video, determine an end time of a program corresponding to the live video played by the second device, according to lastly determined progression information of the video played by the second device; and
transmit a first URL network address corresponding to a channel of the live video to the first device upon determining from the end time that the program corresponding to the live video is not terminated.

14. The non-transitory computer-readable storage medium according to claim 13, wherein the executable instructions executed by the electronic device further cause the electronic device to:
determine a first video list according to the first URL network address corresponding to the video played by the second device bound with the first device; and determine whether there is an end flag in the first video list; and if so, determine that the video played by the second device is an on-demand video; otherwise, determine that the video played by the second device is a live video; or
determine whether the video played by the second device is a live video, according to play state information from the second device; or
request for a list of programs at the first URL network address, and if no list of programs is available, determine that the video played by the second device is an on-demand video; otherwise, determine the video played by the second device is a live video.

15. The non-transitory computer-readable storage medium according to claim 13, wherein the executable instructions executed by the electronic device further cause the electronic device to:
retrieve the latest video list periodically from a live video server corresponding to the first URL network address; and
determine the retrieved latest video list as the first video list.

16. The non-transitory computer-readable storage medium according to claim 13, wherein the executable instructions executed by the electronic device further cause the electronic device to:
obtain a list of programs of the channel of the live video played by the second device, according to the first URL network address, wherein the list of programs comprises start time and end time of each of the programs of the channel; and
determine an end time of a program corresponding to a start time and the end time between which the lastly obtained progression information of the video played by the second device lies, as the end time of the program corresponding to the live video played by the second device.

17. The non-transitory computer-readable storage medium according to claim 13, wherein the executable instructions executed by the electronic device further cause the electronic device to:
determine a second video list according to a second URL network address of the on-demand video of the program upon determining from the end time that the program corresponding to the live video is terminated; and
transmit the second video list, and the lastly obtained progression information of the video played by the second device to the first device.

18. The non-transitory computer-readable storage medium according to claim 13, wherein the executable instructions executed by the electronic device further cause the electronic device to:
receive heartbeat information transmitted by the second device while the second device is playing the live video; and
determine the progression information of the video being played by the second device, according to the heartbeat information each time the heartbeat information is received.
